(19) United States
(12) Patent Application Publication
(10) Pub. No.: US 2023/0283362 A1
(43) Pub. Date: Sep. 7, 2023

(54) BEAM HOPPING METHOD FOR SATELLITE SYSTEM, AND COMMUNICATION APPARATUS

(71) Applicant: HUAWEI TECHNOLOGIES CO., LTD., Shenzhen, Guangdong (CN)

(72) Inventors: Yu WANG, Hangzhou (CN); Yunfei QIAO, Hangzhou (CN); Hejia LUO, Hangzhou (CN); Jun WANG, Hangzhou (CN); Ying CHEN, Hangzhou (CN); Dali QIN, Hangzhou (CN)

(21) Appl. No.: 18/182,075

(22) Filed: Mar. 10, 2023

Related U.S. Application Data
(63) Continuation of application No. PCT/CN2021/115289, filed on Aug. 30, 2021.

(30) Foreign Application Priority Data
Sep. 11, 2020 (CN) 202010955406.0

(51) Int. Cl. H04B 7/204; H04B 7/185

(52) U.S. Cl. CPC H04B 7/2041; H04B 7/18547; H04B 7/18513

(57) ABSTRACT

Example beam hopping methods and apparatus are described. In one example method, a first satellite sends a communication signal to a first area by using a first beam, where the communication signal is used by the first satellite to communicate with a terminal device in the first area, and the first area belongs to an area covered by the first satellite. The first satellite sends a positioning signal to a second area by using a second beam, where the positioning signal is used by a terminal device in the second area for positioning measurement.

### CROSS-REFERENCE TO RELATED APPLICATIONS

This application is a continuation of International Application No. PCT/CN2021/115289, filed on Aug. 30, 2021, which claims priority to Chinese Patent Application No. 202010955406.0, filed on Sep. 11, 2020. The disclosures of the aforementioned applications are hereby incorporated by reference in their entireties.

### TECHNICAL FIELD

This application relates to satellite networks, and more specifically, to a beam hopping method for a satellite system, and a communication apparatus.

### BACKGROUND

Non-terrestrial networks (NTN) such as satellite communication have significant advantages such as global coverage, long-range transmission, flexible networking, easy deployment, and being free from geographical conditions, and have been widely applied to various fields such as maritime communication, positioning and navigation, disaster relief, scientific experiments, video broadcasting, and earth observation. Terrestrial networks and satellite networks are integrated and complement each other, forming a sea-land-air-space-ground integrated communication network that has global seamless coverage, and meeting various ubiquitous service requirements of users.

A next-generation satellite network tends to be ultra-dense and heterogeneous. First, the scale of the satellite network has increased from 66 satellites of the Iridium constellation to 720 satellites of the OneWeb constellation, and finally to 12,000+ low earth orbit satellites of the ultra-dense Starlink constellation. Second, the satellite network becomes heterogeneous, developing from a conventional single-layer communication network to a multi-layer communication network. A communication satellite network also tends to have sophisticated and diversified functions, and is gradually compatible with and supports functions such as navigation enhancement, earth observation, and multi-dimensional information in-orbit processing.

Satellite networks are highly dynamic. For a typical low earth orbit (LEO) satellite, its moving speed is about 7.5 km/s. For a satellite cell with a diameter of 20 km, a user is handed over for about 23 times per minute. This greatly increases complexity and signaling overheads of mobility management of the satellite network. The core of resolving the problems in mobility management of the satellite network lies in user location information. For example, a positioning precision of 10 km can meet basic requirements for cell selection and reselection, and an ultra-narrow beam satellite communication system has a higher requirement for positioning precision. Particularly, for a user without support of a global navigation satellite system (GNSS), how to obtain location information of the user in a timely manner becomes a key to efficient mobility management.

### SUMMARY

This application provides a beam hopping method for a satellite system. Dynamic transformation between a communication beam and a positioning beam can be implemented through flexible beam hopping, so that a conventional communication network can be switched to a network suitable for positioning. This supports implementation of an ICaN system, thereby greatly improving positioning performance of a communication network and implementing high-precision UE self-positioning.

According to a first aspect, a beam hopping method for a satellite system is provided, including: a first terminal device receives a first message sent by a second satellite, where the first message includes information about a first satellite and configuration information for a positioning signal of the first satellite. The first satellite is a neighboring satellite of the second satellite, and the second satellite is a serving satellite of the first terminal device. The first terminal device receives, based on the first message, a positioning signal that is sent by the first satellite by using a second beam. The second beam is a beam generated after a related parameter of a first beam changes, the first beam is a beam used by the first satellite to send a communication signal to a first area, the communication signal is used by the first satellite to communicate with a terminal device in the first area, the first area belongs to an area covered by the first satellite, the second beam is a beam used by the first satellite to send the positioning signal to a second area, the positioning signal is used by a terminal device in the second area for positioning measurement, the second area belongs to an area covered by the second satellite, and the first terminal device is a terminal device in the second area. The first terminal device determines location information of the first terminal device based on a measurement value of the positioning measurement. In the foregoing technical solution, for a beam of the first satellite, dynamic transformation between a communication beam and a positioning beam is implemented through flexible beam hopping, and a positioning reference signal is sent to a terminal device in a coverage area of the neighboring satellite. The terminal device performs positioning measurement based on the positioning reference signal sent by one or more neighboring satellites, so that high-precision UE self-positioning can be implemented without support of a GNSS.

In addition, the introduction of beam hopping further enables a conventional communication network to be switched to a network suitable for positioning. This supports implementation of an ICaN system, thereby greatly improving positioning performance of a communication network.

With reference to the first aspect, in some implementations of the first aspect, the related parameter of the first beam includes one or more of the following parameters: a steering angle, a frequency, a power, a beam shape, a beam quantity, and an antenna gain.

With reference to the first aspect, in some implementations of the first aspect, the first beam is used to send the communication signal to the first area in a first time duration of a broadcast signal periodicity, and the second beam is used to send the positioning signal to the second area in a second time duration of the broadcast signal periodicity, where the first time duration and the second time duration do not overlap.

Optionally, the configuration information for the positioning signal of the first satellite includes a time length of the first time duration and of the second time duration. In the foregoing technical solution, for the beam of the first satellite, dynamic transformation between a communication beam and a positioning beam is implemented through flexible beam hopping in a periodicity of each broadcast signal in a time division manner.

With reference to the first aspect, in some implementations of the first aspect, the positioning measurement includes one or more of the following measurement values: a time of arrival (ToA), a frequency of arrival (FoA), and an angle of arrival (AoA).

With reference to the first aspect, in some implementations of the first aspect, before the first terminal device receives the first message sent by the second satellite, the method further includes: The first terminal device sends a positioning request to the second satellite, where the positioning request is used to request the second satellite to locate the first terminal device.

In the foregoing technical solution, the terminal device may send a positioning request on demand, to support active positioning of the terminal device.

According to a second aspect, a beam hopping method for a satellite system is provided, including: a first satellite sends a communication signal to a first area by using a first beam, where the communication signal is used by the first satellite to communicate with a terminal device in the first area, and the first area belongs to an area covered by the first satellite. The first satellite sends a positioning signal to a second area by using a second beam, where the positioning signal is used by a terminal device in the second area for positioning measurement.

The foregoing technical solution enables a conventional communication network to be switched to a network suitable for positioning. This supports implementation of an ICaN system, thereby greatly improving positioning performance of a communication network.

Optionally, the first satellite may generate a communication beam and a positioning beam at the same time. In this case, the first satellite may provide, by using the communication beam, a communication service for a terminal device in the area covered by the first satellite, and may also provide, by using the positioning beam at the same time, a positioning service for a terminal device in an area covered by another neighboring satellite.

Optionally, the first satellite may not generate a communication beam and a positioning beam at the same time. In this case, for a beam of the first satellite, dynamic transformation between a communication beam and a positioning beam may be implemented through flexible beam hopping, to provide a positioning service for a terminal device of the neighboring satellite. The terminal device performs positioning measurement based on a positioning reference signal sent by one or more first satellites, so that high-precision UE self-positioning can be implemented without support of a GNSS.

With reference to the second aspect, in some implementations of the second aspect, the second beam is a beam generated after a related parameter of the first beam changes, and the related parameter of the first beam includes one or more of the following parameters: a steering angle, a frequency, a power, a beam shape, a beam quantity, and an antenna gain.

With reference to the second aspect, in some implementations of the first aspect, the first satellite sends the communication signal to the first area in a first time duration of a broadcast signal periodicity by using the first beam, and the first satellite sends the positioning signal to the second area in a second time duration of the broadcast signal periodicity by using the second beam, where the first time duration and the second time duration do not overlap.

In the foregoing technical solution, for the beam of the first satellite, dynamic transformation between a communication beam and a positioning beam may be implemented through flexible beam hopping in a periodicity of each broadcast signal in a time division manner.

With reference to the second aspect, in some implementations of the second aspect, the method further includes: the first satellite obtains first indication information, where the first indication information indicates a length of the first time duration and of the second time duration. The first satellite adjusts the length of the first time duration and of the second time duration in the broadcast signal periodicity based on the first indication information.

In the foregoing technical solution, the requirements of the ICaN system for communication and positioning can be dynamically adapted to by flexibly adjusting the time lengths for sending communication slots and positioning slots.

With reference to the second aspect, in some implementations of the second aspect, the positioning measurement includes one or more of the following measurement values: a time of arrival (ToA), a frequency of arrival (FoA), and an angle of arrival (AoA).

With reference to the second aspect, in some implementations of the first aspect, the sending, by the first satellite, a positioning signal to a second area by using a second beam includes: the first satellite periodically sends the positioning signal to the second area, or the first satellite sends the positioning signal to the second area in a pre-configured manner.

With reference to the second aspect, in some implementations of the second aspect, the second area belongs to an area covered by a second satellite, where the second satellite is a neighboring satellite of the first satellite, and before the sending, by the first satellite, a positioning signal to a second area by using a second beam, the method further includes: the first satellite receives a configuration request sent by the second satellite, where the configuration request is used to request the first satellite to assist the second satellite in the positioning measurement. The first satellite sends the positioning signal to the second area by using the second beam and based on the configuration request.

With reference to the second aspect, in some implementations of the second aspect, the configuration request includes a coverage area, a coverage time duration, a power, a frequency, and a polarization direction of the second beam.

According to a third aspect, a communication apparatus is provided. The communication apparatus has a function of implementing the method according to any one of the first aspect or the possible implementations of the first aspect. The function may be implemented by hardware, or may be implemented by hardware executing corresponding software. The hardware or the software includes one or more units corresponding to the foregoing function, for example, a processing unit, a receiving unit, and a sending unit.

According to a fourth aspect, this application provides a communication apparatus, and the communication apparatus has a function of implementing a function of the method according to the second aspect and any possible implementation of the second aspect. The function may be implemented by hardware, or may be implemented by hardware executing corresponding software. The hardware or the software includes one or more units corresponding to the foregoing function, for example, a processing unit, a receiving unit, and a sending unit.

According to a fifth aspect, this application provides a communication device, including at least one processor coupled to at least one memory. The at least one memory is configured to store a computer program or instructions. The at least one processor is configured to invoke the computer program or the instructions from the at least one memory and run the computer program or the instructions, to cause the communication device to perform the method according to any one of the first aspect or the possible implementations of the first aspect.

In an example, the communication device may be a terminal device.

According to a sixth aspect, this application provides a communication device, including at least one processor coupled to at least one memory. The at least one memory is configured to store a computer program or instructions. The at least one processor is configured to invoke the computer program or the instructions from the at least one memory and run the computer program or the instructions, to cause the communication device to perform the method according to any one of the second aspect or the possible implementations of the second aspect.

In an example, the communication device may be a first satellite.

According to a seventh aspect, this application provides a communication device, including a processor, a memory, and a transceiver. The memory is configured to store a computer program. The processor is configured to invoke and run the computer program stored in the memory, and control the transceiver to send/receive a signal, so that the communication device performs the method in the first aspect or any possible implementation of the first aspect.

According to an eighth aspect, this application provides a communication device, including a processor, a memory, and a transceiver. The memory is configured to store a computer program. The processor is configured to invoke and run the computer program stored in the memory, and control the transceiver to send/receive a signal, so that the communication device performs the method in the second aspect or any possible implementation of the second aspect.

According to a ninth aspect, this application provides a communication apparatus, including a processor and a communication interface. The communication interface is configured to receive a signal and transmit the received signal to the processor. The processor processes the signal, so that the communication apparatus performs the method in any one of the first aspect or the possible implementations of the first aspect.

According to a tenth aspect, this application provides a communication apparatus, including a processor and a communication interface. The communication interface is configured to receive a signal and transmit the received signal to the processor. The processor processes the signal, so that the communication apparatus performs the method in any one of the second aspect or the possible implementations of the second aspect.

Optionally, the communication interface may be an interface circuit, an input/output interface, or the like. The processor may be a processing circuit, a logic circuit, or the like.

Optionally, the communication apparatus according to the ninth aspect or the tenth aspect may be a chip or an integrated circuit.

According to an eleventh aspect, this application provides a computer-readable storage medium. The computer-readable storage medium stores computer instructions. When the computer instructions are run on a computer, the method according to any one of the first aspect or the possible implementations of the first aspect is performed.

According to a twelfth aspect, this application provides a computer-readable storage medium. The computer-readable storage medium stores computer instructions. When the computer instructions are run on a computer, the method according to any one of the second aspect or the possible implementations of the second aspect is performed.

According to a thirteenth aspect, this application provides a computer program product. The computer program product includes computer program code. When the computer program code is run on a computer, the method according to any one of the first aspect or the possible implementations of the first aspect is performed.

According to a fourteenth aspect, this application provides a computer program product. The computer program product includes computer program code. When the computer program code is run on a computer, the method according to any one of the second aspect or the possible implementations of the second aspect is performed.

According to a fifteenth aspect, this application provides a wireless communication system, including the communication device according to the seventh aspect and/or the communication device according to the eighth aspect.

### BRIEF DESCRIPTION OF DRAWINGS

FIG. 1 is a schematic diagram of a multi-beam mobile satellite communication system applicable to an embodiment of this application;

FIG. 2 is a schematic diagram of a beam hopping based satellite communication system;

FIG. 3 is a schematic block diagram of a method in a beam hopping based ICaN system design according to this application;

FIG. 4 is a schematic diagram of a communication beam transmission within one slot and a frame structure thereof according to this application;

FIG. 5 is a schematic diagram of positioning beam transmission of a satellite 1 and a neighboring satellite of the satellite 1, and a frame structure of the satellite 1;

FIG. 6 is a schematic diagram of positioning beam transmission of a satellite 2 and a neighboring satellite of the satellite 2, and a frame structure of the satellite 2;

FIG. 7 is a schematic diagram of positioning beam transmission of a satellite 3 and a neighboring satellite of the satellite 3, and a frame structure of the satellite 3;

(a) of FIG. 8 is a schematic diagram of a frame structure of a satellite at a moment 1;

(b) of FIG. 8 is a schematic diagram of a frame structure of a satellite at a moment 2;

FIG. 9 is a schematic block diagram of an ICaN beam hopping method according to this application;

(a) of FIG. 10 is a schematic diagram prior to a beam hopping configuration request among multiple satellites;

(b) of FIG. 10 is a schematic diagram after a beam hopping configuration request among multiple satellites;

FIG. 11 is a schematic block diagram of another ICaN beam hopping method according to this application;

FIG. 12 is a schematic diagram of a UV plane based beam hopping method according to this application;

FIG. 13 is a schematic perspective view of a UV plane based beam hopping method according to this application;

FIG. 14 is a simulation diagram of positioning performance of UV plane based beam hopping for satellites;

FIG. 15 is a schematic diagram of a new beam hopping method based on an earth-centered earth-fixed coordinate system plane according to this application;

FIG. 16 is a schematic block diagram of a communication apparatus 1000 according to this application;

FIG. 17 is a schematic block diagram of a communication apparatus 2000 according to this application;

FIG. 18 is a schematic diagram of a structure of a communication apparatus 10 according to this application; and

FIG. 19 is a schematic diagram of a structure of a communication apparatus 20 according to this application.

### DESCRIPTION OF EMBODIMENTS

The following describes technical solutions of this application with reference to the accompanying drawings.

The technical solutions of this application may be applied to a satellite communication system, high-altitude platform station (HAPS) communication, and other non-terrestrial network (NTN) systems, for example, an integrated communication and navigation (IcaN) system and a global navigation satellite system (GNSS).

The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system (for example, a new radio (NR) system), or a mobile communication system in the future.

The satellite communication system includes a transparent transmission satellite architecture and a non-transparent transmission satellite architecture. The transparent transmission is also referred to as bent-pipe forwarding transmission. To be specific, a signal is subjected to frequency conversion and signal amplification on a satellite. The satellite is transparent to the signal as if it does not exist. The non-transparent transmission is also referred to as regenerative (on-board access/processing) transmission. To be specific, the satellite has some or all base station functions.

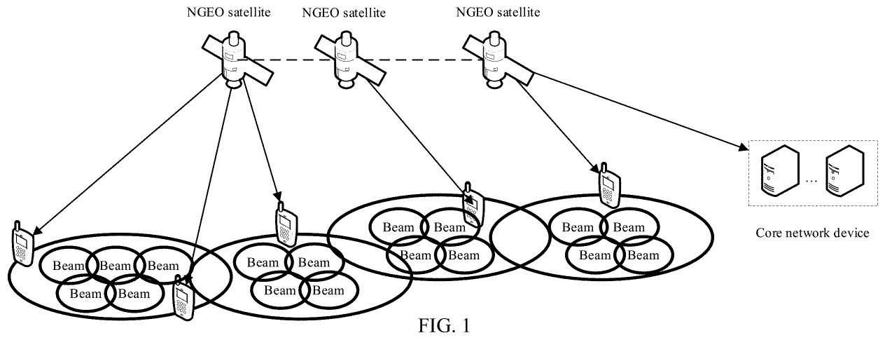

Refer to FIG. 1. FIG. 1 is a schematic diagram of a multi-beam mobile satellite communication system applicable to an embodiment of this application. As shown in FIG. 1, a satellite provides a communication service for a terminal device by using a plurality of beams. The satellite in this scenario is a non-geostationary earth orbit (NGEO) satellite, and the satellite is connected to a core network device. The satellite covers a service area with the plurality of beams. Different beams may communicate with each other by using one or more of time division, frequency division, and space division. The satellite provides communication and navigation services for the terminal device by broadcasting a communication signal and a navigation signal. The satellite is connected to the core network device. The satellite mentioned in the embodiments of this application may also be a satellite base station, or a network side device carried on a satellite.

The terminal device mentioned in the embodiments of this application includes various handheld devices having a wireless communication function, vehicle-mounted devices, wearable devices, computing devices, or other processing devices connected to a wireless modem, and may be specifically user equipment (UE), an access terminal, a subscriber unit, a subscriber station, a mobile station, a mobile console, a remote station, a remote terminal, a mobile device, a user terminal, a terminal, a wireless communication device, a user agent, a user apparatus, or the like. Alternatively, the terminal device may be a satellite phone, a cellular phone, a smartphone, a wireless data card, a wireless modem, a machine type communication device, a cordless phone, a session initiation protocol (SIP) phone, a wireless local loop (WLL) station, a personal digital assistant (PDA), a handheld device with a wireless communication function, a computing device, another processing device connected to a wireless modem, a vehicle-mounted device, a wearable device, a virtual reality (VR) terminal device, an augmented reality (AR) terminal device, a wireless terminal in industrial control, a wireless terminal in self driving (self driving), a wireless terminal in remote medical, a wireless terminal in a smart grid, a wireless terminal in transportation security (transportation safety), a wireless terminal in a smart city, a wireless terminal in a smart home, a terminal device in a 5G network or a future communication network, or the like.

To facilitate understanding of the embodiments of this application, the following first briefly describes terms used in this application.
1. Space division multiplexing: A same frequency band is reused in different spaces. In mobile communication, each beam can provide a unique channel without interference from other users.
2. Time division multiplexing: Different signals are transmitted in different time durations of a same physical connection, which can also achieve multi-channel transmission. In time division multiplexing, time is used as a parameter for signal partitioning. Therefore, channels of signals cannot overlap with each other along a time axis.

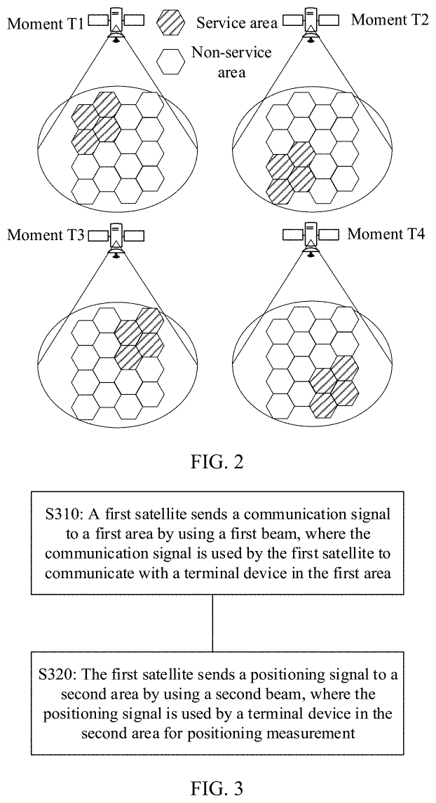

Generally, a single satellite has a wide coverage radius of thousands or even tens of thousands of kilometers, and a single beam has a minimum coverage radius of dozens or even thousands of kilometers. Therefore, to support wide-area coverage, a single high-throughput satellite usually needs to be equipped with hundreds or even thousands of beams, which poses a great challenge to the load of satellites, especially low earth orbit (LEO) satellites. In order to alleviate the contradiction between small load and wide coverage of a single satellite, a beam hopping based satellite communication system emerges. Specifically, in the beam hopping based satellite system, a single satellite is equipped with only a small number of beams (for example, dozens of beams), and the beams serve all coverage areas of the single satellite in a time division manner. Refer to FIG. 2. FIG. 2 is a schematic diagram of a beam hopping based satellite communication system. As shown in FIG. 2, a satellite can form only four beams at a same moment, and at four moments corresponding to T1, T2, T3, and T4, the satellite serves all areas covered by the single satellite (that is, areas corresponding to 16 beams) in a time division manner with four beams filled with slashes corresponding to each of the four moments.

ICaN is a potential development direction of the next-generation communication networks (including satellite networks and terrestrial networks). ICaN can realize the complementary advantages of communication and navigation. ICaN can implement sub-meter-level and high-precision positioning through communication networks, effectively meeting location-based service requirements such as autonomous driving and smart transportation. ICaN can realize the complementary advantages of communication and navigation: from the perspective of communication, location information obtained by positioning (navigation) can be used to implement efficient networking of a network, which greatly simplifies the functions of cell reselection and handover, and location management of a dynamic network (especially the satellite network), and reduces a large amount of control signaling overheads and supports location-based wide area network access. From the perspective of navigation, the introduction of the communication function can enhance navigation and improve positioning precision. Distributing information such as an ephemeris through a communication network can reduce the complexity of satellite search when UE is powered on, and improve a positioning speed of the first network access.

A current beam hopping based satellite system design is mainly used for a communication service. In this application, beam hopping is applied to an ICaN system, and dynamic transformation between a communication beam and a positioning beam is implemented through flexible beam hopping, so that high-precision UE self-positioning can be implemented without support of a GNSS. This can resolve the problem in location-based mobility management in the dynamic network.

Refer to FIG. 3. FIG. 3 is a schematic block diagram of a method for a beam hopping based IcaN system design according to this application.

S310: A first satellite sends a communication signal to a first area by using a first beam, where the communication signal is used by the first satellite to communicate with a first terminal device, the first area belongs to an area covered by the first satellite, the first satellite is a serving satellite of the first terminal device, and the first terminal device is a terminal device in the first area.

It should be noted that the first beam herein may be understood as one or more communication beams.

S320: The first satellite sends a positioning signal to a second area by using a second beam, where the positioning signal is used by a second terminal device for positioning measurement, and the second terminal device is a terminal device in the second area.

It should be noted that the second beam herein may be understood as one or more positioning beams.

Optionally, the second area and the first area may be the same area, and the first satellite is a serving satellite of the second terminal device.

Optionally, the second area belongs to an area covered by a second satellite, the second satellite is a serving satellite of the second terminal device, and the second satellite is a neighboring satellite of the first satellite.

Optionally, the first satellite periodically sends the positioning signal to the second area, or the first satellite sends the positioning signal to the second area in a pre-configured manner, or sends the positioning signal to the second area by using a method configured at the request of another satellite.

Optionally, the communication broadcast signal and the positioning broadcast signal are the same or different. For example, the communication broadcast signal may be a synchronization signal block (synchronization signal and PBCH block, SSB) or an integrated broadcast signal, and the positioning broadcast signal may be an SSB, a (positioning reference signal, PRS), an integrated broadcast signal, or the like.

Optionally, when the second area belongs to the area covered by the second satellite, the second beam is a beam generated after a related parameter of the first beam changes. The related parameter of the first beam includes one or more of the following parameters: a steering angle, a frequency, a power, a beam shape, and an antenna gain. As an example rather than a limitation, in this application, a change of the steering angle is used as an example for detailed description.

Optionally, when the second area belongs to the area covered by the second satellite, the second beam is a beam generated after a related parameter of the first beam changes; the first beam is used to send the communication signal to the first area in a first time duration of a broadcast signal periodicity, and the second beam is used to send the positioning signal to the second area in a second time duration of the broadcast signal periodicity, where the first time duration and the second time duration do not overlap. In other words, a communication beam A is used to provide a communication service for the terminal device in the first area as a communication beam in the first time duration, and after a related parameter of the communication beam A changes, the communication beam A becomes a positioning beam B, which is used to provide a positioning service for the terminal device in the second area in the second time duration.

Optionally, the first satellite may also generate a communication beam and a positioning beam at the same time. For example, the first satellite generates 16 communication beams and eight positioning beams at the same time. In this way, the first satellite may send a communication signal to the first area by using the 16 communication beams, and send a positioning signal to the second area by using the eight positioning signals at the same time.

The following describes the method by using an example.

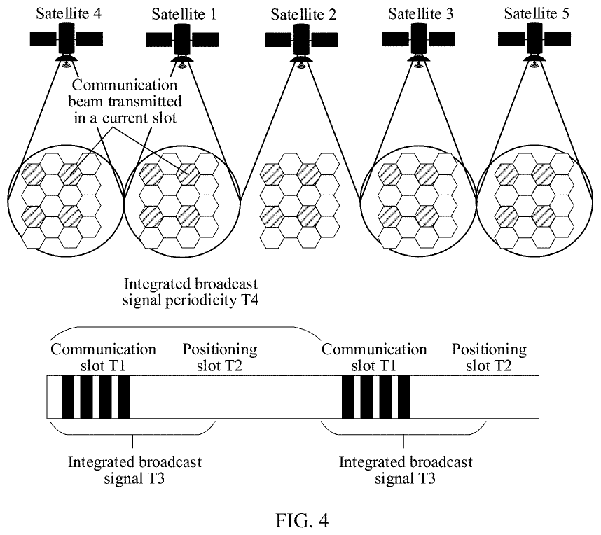

Refer to FIG. 4. FIG. 4 is a schematic diagram of a communication beam transmission within one slot and a frame structure thereof according to this application.

As shown in FIG. 4, a local area network including five satellites is used as an example. All the satellites (namely, a satellite 1 to a satellite 5) transmit a communication signal in a communication time duration T1 (which is an example of the first time duration) by using a communication beam. A target satellite and its neighboring satellites having a positioning requirement transmit a positioning signal in a positioning time duration T2 (which is an example of the second time duration) by using a positioning beam.

In the communication time duration T1, all the satellites transmit an SSB by using the communication beam (with a steering angle alpha=0). Considering space division multiplexing, four SSB beams are transmitted in each slot, and 16 SSB beams may be transmitted in four slots. That is, the communication time duration T1 corresponding to all the satellites accounts for four SSB periodicities.

However, there is a significant difference between positioning broadcast transmissions for different satellites. A steering angle corresponding to a positioning beam of at least one satellite is different from a steering angle of a communication beam. It is assumed that an original steering angle of the communication beam is 0, projections of center points of the communication beam and the positioning beam on the ground are respectively A and B, and the satellite is O. The steering angle of the positioning beam is an included angle between the line segment AO and the line segment BO, that is, the angle AOB.

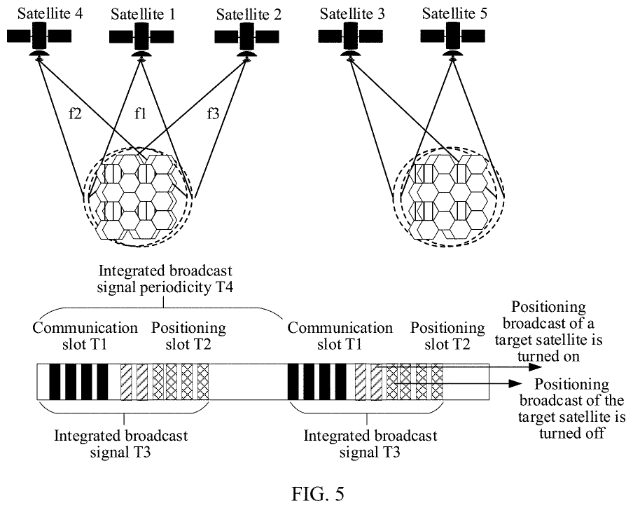

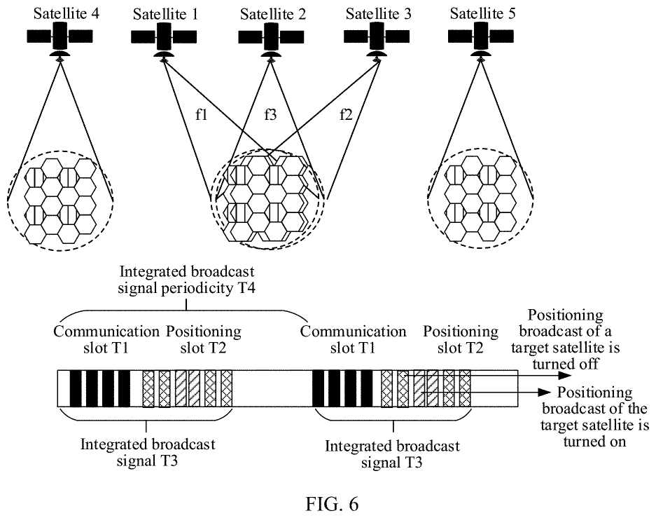

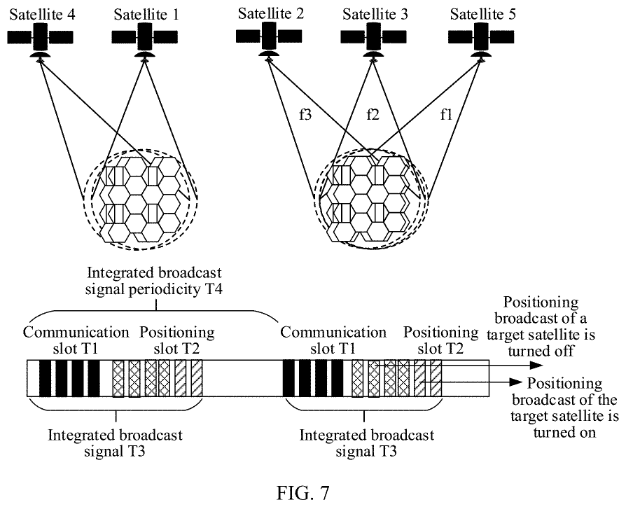

Refer to FIG. 5. FIG. 5 is a schematic diagram of positioning beam transmission of a satellite 1 and a neighboring satellite of the satellite 1, and a frame structure of the satellite 1. As shown in FIG. 5, in order to implement tri-satellite positioning, steering angles of satellites 4 and 2 change (for example, the satellite 4 turns 20 degrees to the right, and the satellite 2 turns 20 degrees to the left), so that the area of the satellite 1 is covered by a plurality of satellites at the same time, thereby completing a multi-satellite positioning function. Specifically, the satellite 1 is used as an example. The satellite 1 turns on positioning broadcast in the first two slots of a positioning time duration T2, but turns off positioning broadcast in subsequent slots and adjusts its beam to help a neighboring satellite in positioning. Refer to FIG. 6. FIG. 6 is a schematic diagram of positioning beam transmission of a satellite 2 and a neighboring satellite of the satellite 2, and a frame structure of the satellite 2. Refer to FIG. 7. FIG. 7 is a schematic diagram of positioning beam transmission of a satellite 3 and a neighboring satellite of the satellite 3, and a frame structure of the satellite 3. As shown in the figures, the satellite 2 and the satellite 3 may also turn on their own positioning broadcast in corresponding slots, and turn off the positioning broadcast in another time duration.

It should be noted that, as can be learned from the frame structures in FIG. 5 to FIG. 7, different satellites perform positioning broadcasting in a time division manner. If a satellite can generate a communication beam and a positioning beam at the same time, different satellites may also perform positioning broadcasting at the same time.

In the foregoing technical solution, the introduction of beam hopping enables a conventional communication network to be switched to a network suitable for positioning. This supports implementation of an IcaN system, thereby greatly improving positioning performance of a communication network.

Based on the beam hopping based IcaN system design, this application further provides a frame structure design and indication method. A length of the communication time duration T1 and of the communication time duration T2 of the satellite in broadcast slots may be dynamically adjusted.

Optionally, a network device may further send first indication information to the first satellite, where the first indication information indicates the length of the communication time duration T1 and of the communication time duration T2.

It may be understood that the network device herein is a terrestrial base station, a satellite base station, or a network side device carried on a satellite.

Optionally, the network device may use a bitmap to indicate configurations of a communication slot bitmap (ComSSBBitmap) and a positioning slot bitmap (PosSSBBitmap). For example, the bitmap configuration information may be placed in a ServingCellConfigCommonSIB information element of a system information block 1 (system information block 1, SIB1). A specific format thereof is as follows:

```
-- ASN1STOP − ASN1START
-- TAG-SIB1-START
ServingCellConfigCommonSIB ::=  SEQUENCE {
    ComSSBBitmap {N1}
    PosSSBBitmap {N2}
}
-- TAG-SIB1-STOP
-- ASN1STOP
```

ComSSBBitmap occupies N1 bits, indicating that the communication slots T1 account for N1 slots, where 1 indicates that the slot is occupied or on, and 0 indicates that the slot is off. PosSSBBitmap occupies N2 bits, indicating that the positioning slots T2 account for N2 slots, where N1+N2=N, and N is a length of the broadcast slots. The method can dynamically adapt to the requirements of the IcaN system for communication and positioning by flexibly adjusting the length of the communication slots and of the positioning slots.

Optionally, the bitmap message may also be transmitted in a message such as another system information block, a media access control (MAC) layer control element (CE), or a radio resource control (RRC) message.

The following describes the frame structure design and indication method by using an example.

Refer to FIG. 8. (a) of FIG. 8 is a schematic diagram of a frame structure of a satellite at a moment 1, and (b) of FIG. 8 is a schematic diagram of a frame structure of a satellite at a moment 2. As shown in FIG. 8, different moments correspond to different frame structures, and one broadcast signal periodicity T4 includes T3 slots, for example, T3=10. In (a) of FIG. 8, at the moment 1, to improve positioning broadcast performance, communication slots T1 account for four slots, while positioning slots T2 account for six slots. In (b) of FIG. 8, at the moment 2, to improve communication broadcast performance, communication slots T1 account for six slots, and positioning slots T2 account for four slots.

Frame structure indications corresponding to the moment 1 and the moment 2 may be as follows:

```
Moment 1
-- ASN1STOP − ASN1START
-- TAG-SIB1-START
ServingCellConfigCommonSIB ::= SEQUENCE {
    ComSSBBitmap {1111}
    PosSSBBitmap {000011}
}
-- TAG-SIB1-STOP
-- ASN1STOP
Moment 2
-- ASN1STOP − ASN1START
-- TAG-SIB1-START
ServingCellConfigCommonSIB ::= SEQUENCE {
  ComSSBBitmap {111111}
  PosSSBBitmap {0011}
}
-- TAG-SIB1-STOP
-- ASN1STOP
```

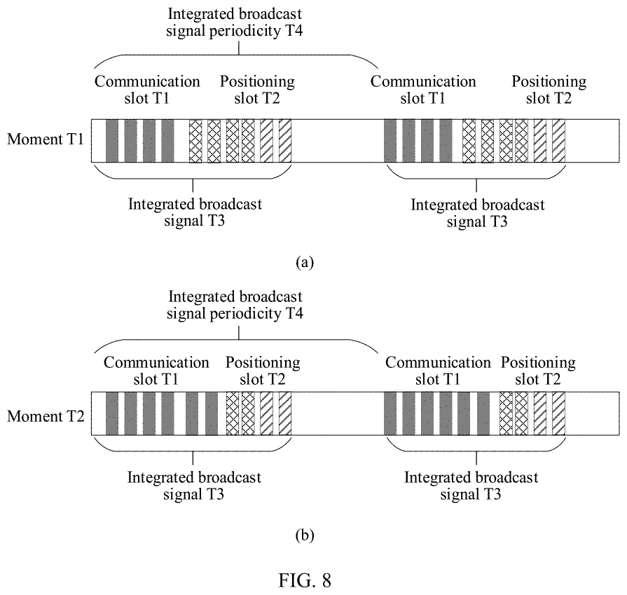

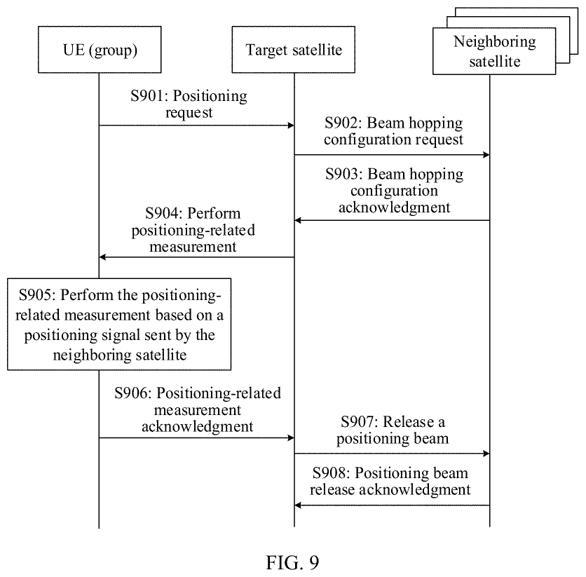

Refer to FIG. 9. FIG. 9 is a schematic block diagram of an IcaN beam hopping method according to this application, which allows a network device to receive an active positioning request of a terminal device and assist in positioning.

S901: A terminal device or a terminal device group sends a positioning request to a target satellite.

It should be understood that the target satellite herein is a serving satellite of the terminal device.

S902: After receiving the positioning request of the terminal device, the target satellite sends a beam hopping configuration request for a positioning beam to one or more neighboring satellites, where a steering angle corresponding to a communication beam of at least one neighboring satellite is different from a steering angle corresponding to the positioning beam.

Optionally, the beam hopping configuration request may include a beam hopping area and a resource configuration request.

Optionally, the beam hopping configuration request may be carried in a newly added beam hopping request (BeamHopRequest) message format, to support transmission of an inter-satellite beam hopping related message. For example, the BeamHopRequest message may be transferred by the target satellite to a neighboring satellite, to indicate configurations such as a coverage area (BeamHoppingArea), a coverage time duration (TimeDuration), a frequency, and a polarization direction (polarization) of beam hopping for the neighboring satellite, where the coverage area of the beam hopping may be in a shape such as a circle, an ellipse, or a rectangle.

S903: The neighboring satellite performs beam hopping based on the configuration request and returns an acknowledgment.

Refer to FIG. 10. (a) of FIG. 10 is a schematic diagram prior to a beam hopping configuration request among multiple satellites, and (b) of FIG. 10 is a schematic diagram after the beam hopping configuration request among the multiple satellites. FIG. 10 is used as an example. After a satellite 1 and a satellite 3 receive a beam hopping configuration request from a satellite 2, steering angles of their beams change, and the beams change from communication beams to positioning beams, to assist a terminal device or a terminal device group in a coverage area of the satellite 2 in positioning.

S904: After receiving a beam hopping configuration request acknowledgment from the neighboring satellite, the target satellite notifies the terminal device or the terminal device group for positioning-related measurement.

S905: The terminal device or the terminal device group performs the positioning-related measurement based on a positioning signal sent by the neighboring satellite.

S906: The terminal device returns an acknowledgment after completing the positioning-related measurement.

Optionally, the positioning-related measurement includes one or more of the following measurements: a time of arrival (ToA), a frequency of arrival (FoA), and an angle of arrival (AoA).

S907: The target satellite notifies the neighboring satellite to release the positioning beam.

S908: The target satellite receives a positioning beam release acknowledgment from the neighboring satellite.

In the foregoing technical solution, a specific procedure of an inter-satellite beam hopping request and on-demand beam hopping of a terminal device is added, which allows for active positioning of the terminal device or the terminal device group.

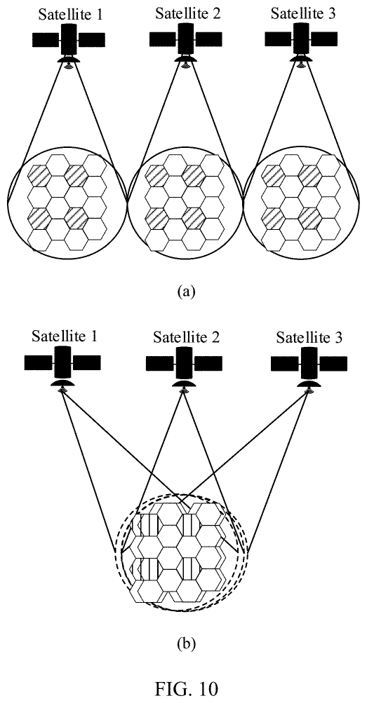

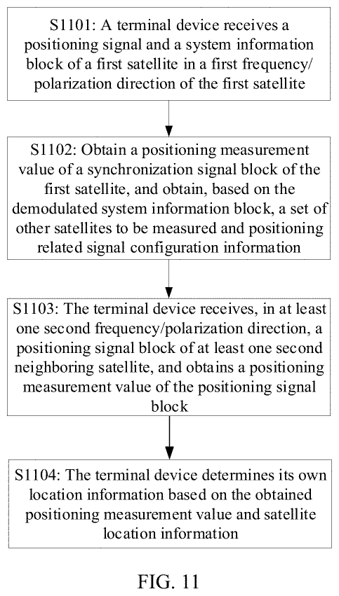

Refer to FIG. 11. FIG. 11 is a schematic block diagram of another ICaN beam hopping method according to this application, which provides a mobility management procedure of passive positioning of a terminal device based on a plurality of satellites.

Optionally, when a location change of the terminal device is greater than a given threshold and/or signal quality of a serving cell is less than a given threshold, the following mobility management procedure is initiated.

S1101: The terminal device receives a system information block from a first satellite.

It may be understood that the first satellite herein is a serving satellite of the terminal device.

It may be understood that the first satellite includes a new positioning assistance message (for example, a set of neighboring satellites, an ephemeris of a neighboring satellite, or a positioning slot bitmap configuration) in the system information block, to notify the terminal device of a necessary assistance message for location calculation.

Optionally, the system information block includes but is not limited to an SIB message and a radio resource control (RRC) message.

Optionally, the terminal device may further receive a positioning signal of the first satellite in a first frequency/polarization direction of the first satellite.

S1102: The terminal device obtains a positioning measurement value of a synchronization signal block of the first satellite, and obtains a set of other satellites to be measured and positioning-related signal configuration information based on the demodulated system information block.

Optionally, the positioning measurement value includes one or more of a ToA value, an FoA value, and an AoA value.

S1103: Based on the set of other satellites to be measured and the positioning-related signal configuration information that are obtained from the system information block, the terminal device receives a positioning signal block of at least one second satellite (that is, the satellite to be measured) in at least one second frequency/polarization direction, and obtains a positioning measurement value of the positioning signal block.

Optionally, the second satellite herein is a neighboring satellite of the first satellite.

It should be noted that the second satellite broadcasts a positioning signal by using a positioning beam in the respective planned slot/frequency/polarization direction.

Optionally, the second satellite periodically sends the positioning signal to the area in which the terminal device is located, or the second satellite sends, in a pre-configured manner, the positioning signal to the area in which the terminal device is located.

S1104: The terminal device determines its own location information based on the obtained positioning measurement value and satellite location information.

Optionally, the terminal device may determine its own location information based on positioning measurement values and satellite location information of at least two satellites.

Optionally, the UE performs cell reselection, cell handover, and tracking area update based on its own location information.

In the foregoing technical solution, the mobility management procedure of passive positioning of a terminal device based on a plurality of satellites is provided, and support of a GNSS is not required, thereby reducing network signaling overheads.

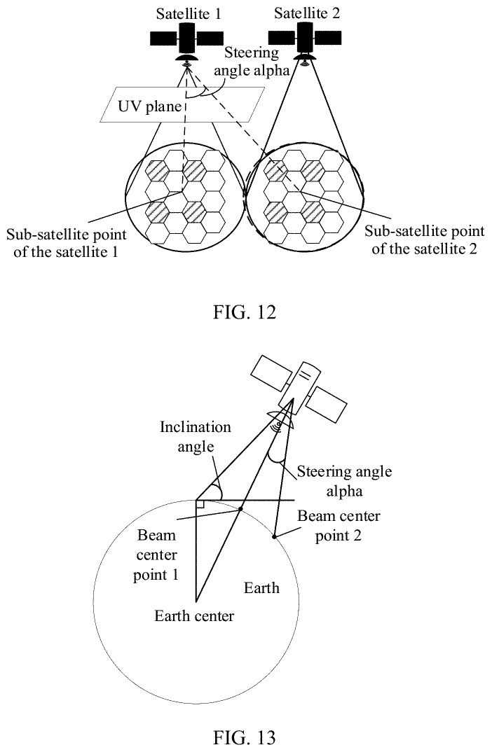

Refer to FIG. 12. FIG. 12 is a schematic diagram of a UV plane based beam hopping method according to this application. The UV plane is a unit plane perpendicular to the connection line between a satellite and the center of the earth. Refer to FIG. 13. FIG. 13 is a schematic perspective view of a UV plane based beam hopping method according to this application. As shown in FIG. 12 and FIG. 13, a beam center point of a satellite 1 is translated on the UV plane, to change from a beam center point 1 to a beam center point 2, a steering angle changes from 0 to alpha, and a satellite beam changes from a communication beam to a positioning beam. The satellite 1 is used as an example. A steering angle corresponding to a communication beam of the satellite 1 is 0, a steering angle corresponding to a positioning beam of the satellite 1 is alpha, an initial point of the communication beam on the UV plane is (u0, v0), and a corresponding point after steering is (u1, v1). In this case, a correspondence therebetween is as follows:

u1=u0+a*cos(alpha)

v1=v0+a*sin(alpha)

a=Re/(Re+h)*sin(theta+90°)

Re is the radius of the earth, h is an orbital height of the satellite, and theta is an inclination angle of a sub-satellite point of a satellite 2 relative to the satellite 1, where the sub-satellite point is a point at which the connection line between the satellite and the center of the earth intersects with the surface of the earth.

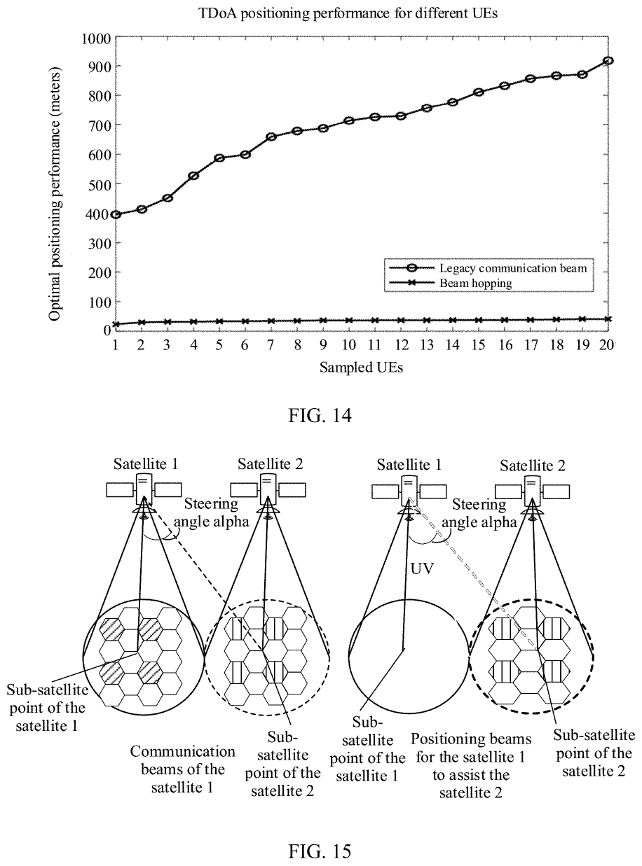

The foregoing technical solution is easy to implement, and greatly improves positioning performance of the ICaN system. Refer to FIG. 14. FIG. 14 is a simulation diagram of positioning performance of UV plane based beam hopping for satellites. As shown in FIG. 14, a Cramer-Rao lower bound (CRLB) for four-satellite time difference of arrival (TDoA) positioning under a network setting of a 30-orbit*80-satellite/orbit constellation, 61 beams per satellite, an orbital height of 1200 km, and a positioning reference signal PSS is provided. It can be learned that UV plane based beam hopping improves performance of conventional positioning based on a communication constellation from a precision of about 400 m to a precision of about 20 m.

Refer to FIG. 15. FIG. 15 is a schematic diagram of a new beam hopping method based on an earth-centered earth-fixed coordinate system plane according to this application, which can reduce a quantity of beams used by a neighboring satellite for assisting in positioning, thereby reducing resource overheads such as power.

From N beams (N is a quantity of communication beams), m (m<N) beams are selected as positioning beams for assisting the neighboring satellite, where S(m−1)<S0 and S(m)>S0, S(m) and S0 are a coverage area or a coverage diameter of the m beams and the positioning beams of the neighboring satellite, respectively. As shown in FIG. 15, a satellite 1 is used as an example, and a quantity of communication beams of the satellite 1 is 16. When the satellite 1 assists a satellite 2 in positioning, an inclination angle of a target area decreases because the beam is steered, and a coverage area of the beam on an earth-centered earth-fixed coordinate system (earth centered earth fixed, ECEF) plane increases. In this case, m (m<N) beams can be used to cover the target area. For example, in FIG. 13, when the satellite 1 switches from a communication beam to a positioning beam, the quantity of beams is reduced from 16 to 12, which effectively reduces resource overheads.

The foregoing describes in detail the method for a broadcast signal design provided in this application. The following describes a communication apparatus provided in this application.

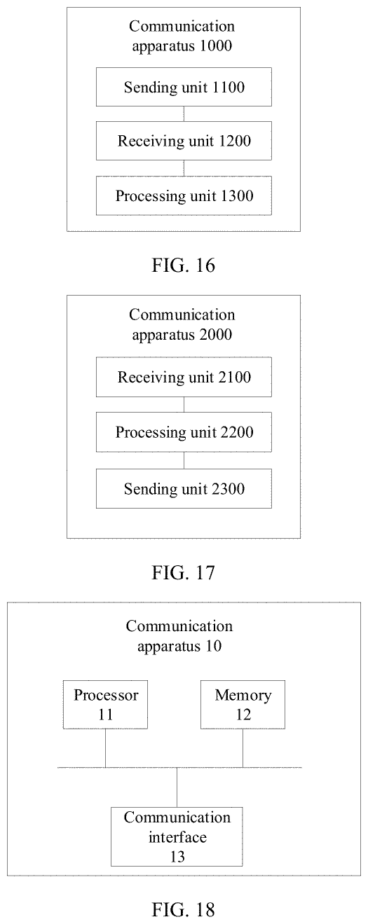

Refer to FIG. 16. FIG. 16 is a schematic block diagram of a communication apparatus 1000 according to this application. As shown in FIG. 16, the communication apparatus 1000 includes a sending unit 1100.

The sending unit 1100 is configured to send a communication signal to a first area by using a first beam, where the communication signal is used by a first satellite to communicate with a terminal device in the first area. The first area belongs to an area covered by the first satellite. The sending unit 1100 is further configured to send a positioning signal to a second area by using a second beam, where the positioning signal is used by a terminal device in the second area for positioning measurement.

Optionally, in an embodiment, the second beam is a beam generated after a related parameter of the first beam changes, and the related parameter of the first beam includes one or more of the following parameters: a steering angle, a frequency, a power, a beam shape, a beam quantity, and an antenna gain.

Optionally, in an embodiment, the sending unit 1100 is specifically configured to: send the communication signal to the first area in a first time duration of a broadcast signal periodicity by using the first beam, and send the positioning signal to the second area in a second time duration of the broadcast signal periodicity by using the second beam, where the first time duration and the second time duration do not overlap.

Optionally, in an embodiment, the communication apparatus further includes: a receiving unit 1200, configured to obtain first indication information, where the first indication information indicates a length of the first time duration and of the second time duration; and a processing unit 1300, configured to adjust the length of the first time duration and of the second time duration in the broadcast signal periodicity based on the first indication information.

Optionally, in an embodiment, the positioning measurement includes one or more of the following measurement values: a time of arrival ToA, a frequency of arrival FoA, and an angle of arrival AoA.

Optionally, in an embodiment, the sending, by the sending unit 1100, a positioning signal to a second area by using a second beam includes: periodically sending, by the sending unit 1100, the positioning signal to the second area, or sending, by the sending unit 1100, the positioning signal to the second area in a pre-configured manner.

Optionally, in an embodiment, the second area belongs to an area covered by a second satellite, where the second satellite is a neighboring satellite of the first satellite, and before the sending unit 1100 sends the positioning signal to the second area by using the second beam, the receiving unit 1200 is configured to receive a configuration request sent by the second satellite, where the configuration request is used to request the first satellite to assist the second satellite in the positioning measurement. The processing unit 1300 is configured to send the positioning signal to the second area by using the second beam and based on the configuration request.

Optionally, in an embodiment, the configuration request includes a coverage area, a coverage time duration, a power, a frequency, and a polarization direction of the second beam.

In the foregoing implementations, the receiving unit 1200 and the sending unit 1100 may also be integrated into one transceiver unit, and have both of a receiving function and a sending function. This is not limited herein.

Optionally, in an example, the receiving unit 1200 in the communication apparatus 1000 may be a receiver, and the sending unit 1100 may be a transmitter. Alternatively, the receiver and the transmitter may be integrated into a transceiver.

Optionally, in another example, the communication apparatus 1000 may be a chip or an integrated circuit. In this case, the receiving unit 1200 and the sending unit 1100 may be a communication interface or an interface circuit. For example, the receiving unit 1200 is an input interface or an input circuit, and the sending unit 1100 is an output interface or an output circuit.

In various examples, the processing unit 1300 is configured to perform processing and/or operations to be implemented in the communication apparatus except the sending and receiving actions.

The processing unit 1300 may be a processing apparatus. A function of the processing apparatus may be implemented by hardware, or may be implemented by hardware executing corresponding software. For example, the processing apparatus may include at least one processor and at least one memory. The at least one memory is configured to store a computer program. The at least one processor reads and executes the computer program stored in the at least one memory, so that the communication apparatus 1000 performs the operations and/or processing to be performed on a terminal device side in the foregoing embodiments.

Optionally, the processing apparatus may include only the processor, and the memory configured to store the computer program is located outside the processing apparatus. The processor is connected to the memory through a circuit/wire, to read and execute the computer program stored in the memory.

Optionally, in some examples, the processing apparatus may alternatively be a chip or an integrated circuit. For example, the processing apparatus includes a processing circuit/logic circuit and an interface circuit. The interface circuit is configured to: receive a signal and/or data, and transmit the signal and/or the data to the processing circuit. The processing circuit processes the signal and/or the data, so that operations and/or processing performed by the terminal device in the method embodiments are performed.

Refer to FIG. 17. FIG. 17 is a schematic block diagram of a communication apparatus 2000 according to this application. As shown in FIG. 17, the communication apparatus 2000 includes a receiving unit 2100 and a processing unit 2200.

The receiving unit 2100 is configured to receive a first message sent by a second satellite, where the first message includes information about a first satellite and configuration information for a positioning signal of the first satellite. The first satellite is a neighboring satellite of the second satellite, and the second satellite is a serving satellite of a first terminal device equipped with the communication apparatus. The receiving unit 2100 is further configured to receive, based on the first message, a positioning signal that is sent by the first satellite by using a second beam. The second beam is a beam generated after a related parameter of a first beam changes, the first beam is a beam used by the first satellite to send a communication signal to a first area, the communication signal is used by the first satellite to communicate with a terminal device in the first area, the first area belongs to an area covered by the first satellite, the second beam is a beam used by the first satellite to send the positioning signal to a second area, the positioning signal is used by a terminal device in the second area for positioning measurement, the second area belongs to an area covered by the second satellite, and the first terminal device is a terminal device in the second area.

The processing unit 2200 is configured to determine location information of the first terminal device based on a measurement value of the positioning measurement.

Optionally, in an embodiment, the related parameter of the first beam includes one or more of the following parameters: a steering angle, a frequency, a power, a beam shape, a beam quantity, and an antenna gain.

Optionally, in an embodiment, the first beam is used to send the communication signal to the first area in a first time duration of a broadcast signal periodicity, and the second beam is used to send the positioning signal to the second area in a second time duration of the broadcast signal periodicity, where the first time duration and the second time duration do not overlap.

Optionally, in an embodiment, the positioning measurement includes one or more of the following measurement values: a time of arrival (ToA), a frequency of arrival (FoA), and an angle of arrival (AoA).

Optionally, the communication apparatus further includes a sending unit 2300.

Optionally, in an embodiment, before the receiving unit 2100 receives the first message sent by the second satellite, the sending unit 2300 is configured to send a positioning request to the second satellite, where the positioning request is used to request the second satellite to locate the first terminal device.

In the foregoing implementations, the receiving unit 2100 and the sending unit 2300 may also be integrated into one transceiver unit, and have both of a receiving function and a sending function. This is not limited herein.

Optionally, in an example, the communication apparatus 2000 may be the satellite or the network device in the method embodiments. In this case, the receiving unit 2100 may be a receiver, and the sending unit 2300 may be a transmitter. Alternatively, the receiver and the transmitter may be integrated into a transceiver.

Optionally, in another example, the communication apparatus 2000 may be a satellite or a chip or an integrated circuit in a network device. In this case, the receiving unit 2100 and the sending unit 2300 may be a communication interface or an interface circuit. For example, the receiving unit 2100 is an input interface or an input circuit, and the sending unit 2300 is an output interface or an output circuit.

Optionally, the communication apparatus 2000 may further include a processing unit 2200. In various examples, the processing unit 2200 is configured to perform processing and/or operations implemented inside the network device except the sending and receiving actions.

The processing unit 2200 may be a processing apparatus. A function of the processing apparatus may be implemented by hardware, or may be implemented by hardware executing corresponding software. For example, the processing apparatus may include at least one processor and at least one memory. The at least one memory is configured to store a computer program. The at least one processor reads and executes the computer program stored in the at least one memory, to cause the communication apparatus 2000 to perform the operations and/or processing performed by the first satellite in the method embodiments.

Optionally, the processing apparatus may include only the processor, and the memory configured to store the computer program is located outside the processing apparatus. The processor is connected to the memory through a circuit/wire, to read and execute the computer program stored in the memory.

Optionally, in some examples, the processing apparatus may alternatively be a chip or an integrated circuit. For example, the processing apparatus includes a processing circuit/logic circuit and an interface circuit. The interface circuit is configured to: receive a signal and/or data, and transmit the signal and/or the data to the processing circuit. The processing circuit processes the signal and/or the data, so that operations performed by the network device in the method embodiments are performed.

Refer to FIG. 18. FIG. 18 is a schematic diagram of a structure of a communication apparatus 10 according to this application. As shown in FIG. 18, the communication apparatus 10 includes one or more processors 11, one or more memories 12, and one or more communication interfaces 13. The processor 11 is configured to control the communication interface 13 to receive and send a signal. The memory 12 is configured to store a computer program. The processor 11 is configured to invoke the computer program from the memory 12 and run the computer program, to cause the procedures and/or the operations performed by the first satellite in the method embodiments of this application to be performed.

For example, the processor 11 may have a function of the processing unit 1300 shown in FIG. 16, and the communication interface 13 may have a function of the receiving unit 1200 and/or the sending unit 1100 shown in FIG. 16. Specifically, the processor 11 may be configured to perform the processing or operations to be internally performed by the terminal device in the method embodiments of this application, and the communication interface 13 is configured to perform the sending and/or receiving actions to be performed by the first satellite in the method embodiments of this application.

In an implementation, the communication interface 13 in the communication apparatus 10 may be a transceiver. The transceiver may include a receiver and a transmitter. Optionally, the processor 11 may be a baseband apparatus, and the communication interface 13 may be a radio frequency apparatus. In another implementation, the communication apparatus 10 may be a chip or an integrated circuit. In this implementation, the communication interface 13 may be an interface circuit or an input/output interface.

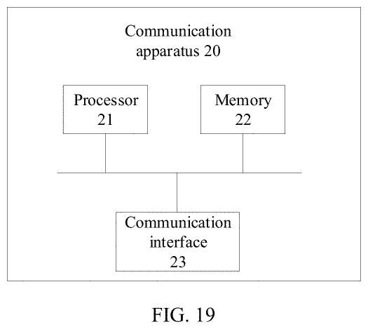

Refer to FIG. 19. FIG. 19 is a schematic diagram of a structure of a communication apparatus 20 according to this application. As shown in FIG. 19, the communication apparatus 20 includes one or more processors 21, one or more memories 22, and one or more communication interfaces 23. The processor 21 is configured to control the communication interface 23 to receive and send a signal. The memory 22 is configured to store a computer program. The processor 21 is configured to invoke the computer program from the memory 22 and run the computer program, to cause the procedures and/or the operations performed by the first terminal device in the method embodiments of this application to be performed.

For example, the processor 21 may have a function of the processing unit 2200 shown in FIG. 17, and the communication interface 23 may have a function of the receiving unit 2100 and/or the sending unit 2300 shown in FIG. 17. Specifically, the processor 21 may be configured to perform the processing or operations internally performed by the network device in the method embodiments of this application, and the communication interface 23 is configured to perform the sending and/or receiving actions performed by the first terminal device in FIG. 7.

In an implementation, the communication apparatus 20 may be the first terminal device in the method embodiments. In this implementation, the communication interface 23 may be a transceiver. The transceiver may include a receiver and a transmitter. Optionally, the processor 21 may be a baseband apparatus, and the communication interface 23 may be a radio frequency apparatus. In another implementation, the communication apparatus 20 may be a chip or an integrated circuit installed in a network device. In this implementation, the communication interface 23 may be an interface circuit or an input/output interface.

Optionally, the memory and the processor in the foregoing apparatus embodiments may be physically independent units, or the memory may be integrated into the processor. This is not limited in this specification.

In addition, this application further provides a computer-readable storage medium. The computer-readable storage medium stores computer instructions. When the computer instructions are run on a computer, operations and/or procedures performed by the first terminal device in the method embodiments of this application are performed.

This application further provides a computer-readable storage medium. The computer-readable storage medium stores computer instructions. When the computer instructions are run on a computer, the operations and/or procedures performed by the first satellite in the method embodiments of this application are performed.

In addition, this application further provides a computer program product. The computer program product includes computer program code or instructions. When the computer program code or the instructions are run on a computer, operations and/or procedures performed by the first terminal device in the method embodiments of this application are performed.

This application further provides a computer program product. The computer program product includes computer program code or instructions. When the computer program code or the instructions is/are run on a computer, the operations and/or procedures performed by the first satellite in the method embodiments of this application are performed.

In addition, this application further provides a chip. The chip includes a processor. A memory configured to store a computer program is disposed independently of a chip, and the processor is configured to execute the computer program stored in the memory, so that an operation and/or processing performed by the first terminal device in any method embodiment is performed.

Further, the chip may include a communication interface. The communication interface may be an input/output interface, an interface circuit, or the like. Further, the chip may include the memory.

This application further provides a chip including a processor. The memory configured to store the computer program is independent of the chip. The processor is configured to execute the computer program stored in the memory, so that the operations and/or processing performed by the first satellite in any method embodiment are performed.

Further, the chip may include a communication interface. The communication interface may be an input/output interface, an interface circuit, or the like. Further, the chip may include the memory.

In addition, this application further provides a communication apparatus (for example, may be a chip), including a processor and a communication interface. The communication interface is configured to receive a signal and transmit the signal to the processor, and the processor processes the signal, so that the operations and/or processing performed by the first terminal device in any method embodiment are performed.

This application further provides a communication apparatus (which, for example, may be a chip), including a processor and a communication interface. The communication interface is configured to receive a signal and transmit the signal to the processor. The processor processes the signal, so that the operations and/or processing performed by the first satellite in any method embodiment are performed.

In addition, this application further provides a communication apparatus, including at least one processor, the at least one processor is coupled to at least one memory, and the at least one processor is configured to execute a computer program or instructions stored in the at least one memory, so that the operations and/or processing performed by the first terminal device in any method embodiment are performed.

This application further provides a communication apparatus, including at least one processor coupled to at least one memory. The at least one processor is configured to execute a computer program or instructions stored in the at least one memory, so that the operations and/or processing performed by the first satellite in any method embodiment are performed.

In addition, this application further provides a communication device, including a processor, a memory, and a transceiver. The memory is configured to store a computer program. The processor is configured to invoke and run the computer program stored in the memory, and control the transceiver to receive and send a signal, so that the first terminal device performs the operations and/or processing performed by the first terminal device in any method embodiment.

This application further provides a communication device, including a processor, a memory, and a transceiver. The memory is configured to store a computer program. The processor is configured to invoke and run the computer program stored in the memory, and control the transceiver to receive and send a signal, so that the terminal device performs the operations and/or processing performed by the first satellite in any method embodiment.

In addition, this application further provides a wireless communication system, including the first terminal device and the first satellite in the embodiments of this application.

A processor in the embodiments of this application may be an integrated circuit chip, and has a signal processing capability. In an implementation process, the steps in the foregoing method embodiments are implemented by using a hardware integrated logic circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The general-purpose processor may be a microprocessor, or the processor may be any conventional processor or the like. The steps of the methods disclosed in the embodiments of this application may be directly presented as being performed and completed by a hardware encoding processor, or performed and completed by a combination of hardware and a software module in an encoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

A memory in the embodiments of this application may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), and is used as an external cache. Through example but non-limiting description, RAMs in many forms are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DRRAM). It should be noted that the memory in the systems and methods described herein is intended to include but is not limited to these and any other suitable type of memory.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in the embodiments of this application may be integrated into one processing unit, each of the units may exist alone physically, or two or more units may be integrated into one unit.

The term “and/or” in this application describes only an association relationship between associated objects and represents that three relationships may exist. For example, A and/or B may represent the following three cases: only A exists, both A and B exist, and only B exists. A, B, and C each may be singular or plural. This is not limited.

In the embodiments of this application, the terms such as “first” and “second” are used to distinguish between same items or similar items having basically same functions and effects. A person skilled in the art may understand that the terms such as “first” and “second” do not limit a quantity or an execution sequence, and the terms such as “first” and “second” do not indicate a definite difference.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A beam hopping method for a satellite system, comprising:
sending, by a first satellite, a communication signal to a first area by using a first beam, wherein the communication signal is used by the first satellite to communicate with a terminal device in the first area, and the first area belongs to an area covered by the first satellite; and
sending, by the first satellite, a positioning signal to a second area by using a second beam, wherein the positioning signal is used by a terminal device in the second area for positioning measurement.

2. The beam hopping method according to claim 1, wherein the second beam is generated after a related parameter of the first beam changes, and the related parameter of the first beam comprises one or more of the following parameters: a steering angle, a frequency, a power, a beam shape, a beam quantity, or an antenna gain.

3. The beam hopping method according to claim 2, wherein the beam hopping method further comprises:
sending, by the first satellite, the communication signal to the first area in a first time duration of a broadcast signal periodicity by using the first beam; and
sending, by the first satellite, the positioning signal to the second area in a second time duration of the broadcast signal periodicity by using the second beam, wherein the first time duration and the second time duration do not overlap.

4. The beam hopping method according to claim 3, wherein the beam hopping method further comprises:
obtaining, by the first satellite, first indication information, wherein the first indication information indicates a length of the first time duration and a length of the second time duration; and
adjusting, by the first satellite, the length of the first time duration and the length of the second time duration in the broadcast signal periodicity based on the first indication information.

5. The beam hopping method according to claim 4, wherein the first indication information is carried in any one of the following messages: a radio resource control (RRC) message, a system information block (SIB) message, or a media access control layer control element (MAC CE) message.

6. The beam hopping method according to claim 1, wherein the positioning measurement comprises measuring one or more of the following measurement values: a time of arrival (ToA), a frequency of arrival (FoA), or an angle of arrival (AoA).

7. The beam hopping method according to claim 1, wherein the sending, by the first satellite, a positioning signal to a second area by using a second beam comprises:
periodically sending, by the first satellite, the positioning signal to the second area; or
sending, by the first satellite, the positioning signal to the second area in a pre-configured manner.

8. The beam hopping method according to claim 1, wherein:
the second area belongs to an area covered by a second satellite; and
before the sending, by the first satellite, a positioning signal to a second area by using a second beam, the beam hopping method further comprises:
receiving, by the first satellite, a configuration request sent by the second satellite, wherein the configuration request is used to request the first satellite to assist the second satellite in the positioning measurement; and
sending, by the first satellite, the positioning signal to the second area by using the second beam and based on the configuration request.

9. The beam hopping method according to claim 8, wherein the configuration request comprises a coverage area, a coverage time duration, a power, a frequency, and a polarization direction of the second beam.

10. A beam hopping method for a satellite system, comprising:
receiving, by a first terminal device, a first message sent by a second satellite, wherein the first message comprises information about a first satellite and configuration information for a positioning signal of the first satellite, wherein the first satellite is a neighboring satellite of the second satellite, and the second satellite is a serving satellite of the first terminal device;
receiving, by the first terminal device based on the first message, a positioning signal sent by the first satellite by using a second beam, wherein:
the second beam is generated after a related parameter of a first beam changes,
the first beam is used by the first satellite to send a communication signal to a first area,
the communication signal is used by the first satellite to communicate with a terminal device in the first area,
the first area belongs to an area covered by the first satellite,
the second beam is used by the first satellite to send the positioning signal to a second area,
the positioning signal is used by a terminal device in the second area for positioning measurement,
the second area belongs to an area covered by the second satellite, and
the first terminal device is in the second area; and
determining, by the first terminal device, location information of the first terminal device based on a measurement value of the positioning measurement.

11. The beam hopping method according to claim 10, wherein the related parameter of the first beam comprises one or more of the following parameters: a steering angle, a frequency, a power, a beam shape, a beam quantity, or an antenna gain.

12. The beam hopping method according to claim 10, wherein:
the first beam is used to send the communication signal to the first area in a first time duration of a broadcast signal periodicity, and
the second beam is used to send the positioning signal to the second area in a second time duration of the broadcast signal periodicity, wherein the first time duration and the second time duration do not overlap.

13. The beam hopping method according to claim 10, wherein the positioning measurement comprises one or more of the following measurement values: a time of arrival (ToA), a frequency of arrival (FoA), or an angle of arrival (AoA).

14. The beam hopping method according to claim 10, wherein before the receiving, by a first terminal device, a first message sent by a second satellite, the beam hopping method further comprises:
sending, by the first terminal device, a positioning request to the second satellite, wherein the positioning request is used to request the second satellite to locate the first terminal device.

15. A communication apparatus, comprising:
at least one processor; and
one or more memories coupled to the at least one processor and storing programming instructions for execution by the at least one processor to:
send a communication signal to a first area by using a first beam, wherein the communication signal is used by a first satellite to communicate with a terminal device in the first area, and the first area belongs to an area covered by the first satellite; and
send a positioning signal to a second area by using a second beam, wherein the positioning signal is used by a terminal device in the second area for positioning measurement.

16. The communication apparatus according to claim 15, wherein:
the second beam is generated after a related parameter of the first beam changes, and
the related parameter of the first beam comprises one or more of the following parameters: a steering angle, a frequency, a power, a beam shape, a beam quantity, or an antenna gain.

17. The communication apparatus according to claim 16, wherein the one or more memories store the programming instructions for execution by the at least one processor to:
send the communication signal to the first area in a first time duration of a broadcast signal periodicity by using the first beam; and
send the positioning signal to the second area in a second time duration of the broadcast signal periodicity by using the second beam, wherein the first time duration and the second time duration do not overlap.

18. The communication apparatus according to claim 17, wherein the one or more memories store the programming instructions for execution by the at least one processor to:
obtain first indication information, wherein the first indication information indicates a length of the first time duration and a length of the second time duration; and
adjust the length of the first time duration and the length of the second time duration in the broadcast signal periodicity based on the first indication information.

19. The communication apparatus according to claim 18, wherein the first indication information is carried in any one of the following messages: a radio resource control (RRC) message, a system information block (SIB) message, or a media access control layer control element (MAC CE) message.

20. The communication apparatus according to claim 15, wherein the positioning measurement comprises measuring one or more of the following measurement values: a time of arrival (ToA), a frequency of arrival (FoA), or an angle of arrival (AoA).
